(19) United States
(12) Patent Application Publication
(10) Pub. No.: US 2017/0277013 A1
(43) Pub. Date: Sep. 28, 2017

(54) OPTICAL DEVICE AND OPTICAL SWITCH

(71) Applicant: FUJIKURA LTD., Tokyo (JP)

(72) Inventors: Daisuke Awaji, Sakura-shi, Chiba (JP); Shinichi Sakamoto, Sakura-shi (JP)

(73) Assignee: FUJIKURA LTD., Tokyo (JP)

(21) Appl. No.: 15/509,136

(22) PCT Filed: Apr. 4, 2016
(86) PCT No.: PCT/JP2016/061014

§ 371 Date: Mar. 6, 2017

(30) Foreign Application Priority Data
Jun. 19, 2015 (JP) 2015-124186

(51) Int. Cl. G02F 1/31

(52) U.S. Cl. CPC G02F 1/31

(57) ABSTRACT

An optical device (10) includes an LCOS element (3), a heater substrate (2), and a resin layer (4) provided between the LCOS element (3) and the heater substrate (2), the resin layer (4) having a larger thickness at a central region of the LCOS element (3) than at a peripheral region of the LCOS element (3).

### TECHNICAL FIELD

The present invention relates to an optical device in which an optical element is fixed to a heater substrate via a resin layer, and an optical switch including the optical device.

### BACKGROUND ART

There have been optical switches using optical elements such as an LCOS (Liquid Crystal On Silicon) element and an MEMS (Micro Electro Mechanical System) mirror element (see, for example, Patent Literatures 1 and 2). The LCOS element and the MEMS mirror element are each a spatial optical modulator having a function of controlling an angle of reflective light.

It is known that it is desirable to use an LCOS element at a high temperature (a temperature higher than a normal temperature) in order to increase a switching speed of the LCOS element. Accordingly, an optical switch including the LCOS element is sometimes configured such that the LCOS element is fixed to a heater substrate via a resin layer and the LCOS element is heated using the heater substrate.

### CITATION LIST

### Patent Literatures

[Patent Literature 1]

Japanese Patent Application Publication, Tokukai, No. 2011-8105 (Published on Jan. 13, 2011)

[Patent Literature 2]

Japanese Translation of PCT International Application, Tokuhyo, No. 2007-524112 (Published on Aug. 23, 2007)

### SUMMARY OF INVENTION

### Technical Problem

In a case where the LCOS element is fixed to the heater substrate via the resin layer, if concavity and convexity due to waviness, a foreign matter, scar etc. exist on a surface of the heater substrate which surface faces the LCOS element (interface of the heater substrate with the resin layer), the LCOS element is sometimes deformed along the concavity and convexity. In particular, a central region of the LCOS element is likely to be influenced by the concavity and convexity. This is explained below.

Since the LCOS element is constituted by laminating different types of materials with different expansion coefficients, it is often that the LCOS element is curved spherically in such a manner that an incident surface has a depressed center. Consequently, as illustrated in FIG. 5, in a conventional optical device 100 in which an LCOS element 30 which is curved spherically is fixed to a heater substrate 20 via a resin layer 40, since the resin layer 4 at a central region of the LCOS element 30 has a small thickness (is thin), the central region of the LCOS element 30 is likely to deform along the concavity and convexity of the heater substrate 20. The LCOS element 30 normally has an active region (a region where a liquid crystal layer is formed) at its central region. Accordingly, deformation of the central region of the LCOS element 30 results in a decrease in optical performance of the LCOS element 30. In a case where deformation of the central region of the LCOS element 30 is large, there is a possibility that the LCOS element 30 cannot be controlled to emit reflective light at a desired angle.

The present invention was made in view of the foregoing problem. An object of an aspect of the present invention is to realize an optical device which does not suffer a significant decrease in optical performance even if a surface of a heater substrate has concavity and convexity.

### Solution to Problem

In order to solve the foregoing problem, an optical device of an aspect of the present invention includes: an optical element; a heater substrate for heating the optical element; and a resin layer provided between the optical element and the heater substrate, the resin layer having a larger thickness at a central region of the optical element than at a peripheral region of the optical element.

### Advantageous Effects of Invention

The present invention can realize an optical device which does not suffer a significant decrease in optical performance, even if a surface of a heater substrate has concavity and convexity.

### BRIEF DESCRIPTION OF DRAWINGS

(a) of FIG. 1 is a cross sectional view of an optical device in accordance with one embodiment of the present invention. (b) of FIG. 1 is a perspective view of an optical switch using the optical device.

(a) of FIG. 2 is a top view of a heater substrate used in the optical device in accordance with one embodiment of the present invention. (b) of FIG. 2 is a cross sectional view of the heater substrate whose concavity and convexity on a surface are omitted.

FIG. 3 is a cross sectional view of the optical device in accordance with one embodiment of the present invention, in which concavity and convexity on a surface of the heater substrate is shown in an enlarged manner.

(a) to (c) of FIG. 4 are cross sectional views of modifications of the optical device in accordance with one embodiment of the present invention.

FIG. 5 is a cross sectional view of a conventional optical device.

### DESCRIPTION OF EMBODIMENTS

### Embodiment

The following description will discuss an embodiment of the present invention with reference to drawings. In the present embodiment, a description will be made as to an optical device 10 including an LCOS (Liquid Crystal On Silicon) element 3 as an optical element.

### Configuration of Optical Device

(a) of FIG. 1 is a cross sectional view illustrating the optical device 10 in accordance with the present embodiment. As illustrated in (a) of FIG. 1, the optical device 10 includes the LCOS element 3, a heater substrate 2, and a resin layer 4 provided between the LCOS element 3 and the heater substrate 2.

The LCOS element 3 is a spatial optical modulator having a function of controlling an angle of reflective light. The LCOS element 3 is constituted by laminating a glass layer 3c on a silicon layer 3b with a liquid crystal layer 3a therebetween. Since the LCOS element 3 is constituted by laminating the silicon layer 3b and the glass layer 3c with different expansion coefficients as above, the LCOS element 3 is likely to be curved spherically in such a manner that an incident surface has a depressed center, as illustrated in (a) of FIG. 1.

The silicon layer 3b is formed by providing, on a silicon substrate, a driving circuit for driving the LCOS element 3. An interface of the silicon layer 3b with the liquid crystal layer 3a is mirror-like. The liquid crystal layer 3a is a light-receiving section of the LCOS element 3, and includes a liquid crystal, an orientation film etc. A region of the LCOS element 3 at which region the liquid crystal layer 3a is present serves as an active region. The LCOS element 3 changes an orientation of the liquid crystal depending on a change in a voltage applied on the liquid crystal layer 3a, so as to change a reflective angle of light incident to the liquid crystal layer 3a. That is, by controlling a voltage, the LCOS element 3 can control a reflective angle.

The heater substrate 2 is a heating (warming) device. In the present embodiment, the heater substrate 2 is a ceramic heater in which a heating circuit (not illustrated) and a temperature control circuit (not illustrated) are provided on a heater substrate made of a ceramic material. Examples of the ceramic material for the heater substrate include alumina, aluminum nitride, silicon nitride, and barium titanate. Alternatively, the heater substrate may be made of, for example, copper, iron, SUS, and/or NCF.

Use of the LCOS element 3 while heating it by the heater substrate 2 (e.g. heated at 60° C.) can realize an increased orientation speed of the liquid crystal as compared to that at a normal temperature. Accordingly, use of the optical device 10 as an optical switch as described later can realize an increased switching speed.

(a) of FIG. 2 is a top view of the heater substrate 2. (b) of FIG. 2 is a cross sectional view of the heater substrate. As illustrated in (a) and (b) of FIG. 2, the heater substrate 2 has a concave section 24 at a surface facing the LCOS element 3, and so has a mortar shape with its center depressed.

The LCOS element 3 and the heater substrate 2 are connected with electrode terminals (not illustrated) via, e.g. wire bonding so as to attain conduction with outside. Since a known technique is applicable to this connection, an explanation thereof is omitted.

The resin layer 4 is a layer for fixing the LCOS element 3 to the heater substrate 2, and is made of a resin. In order that the resin layer 4 efficiently transmits heat from the heater substrate 2 to the LCOS element 3, the resin for the resin layer 4 is preferably one which has sufficient thermal conductivity and which is difficult to be deteriorated due to heat from the heater substrate 2. Preferable examples of the resin include epoxy resin and acrylic resin. These resins fix the LCOS element 3 to the heater substrate 2 by thermal curing.

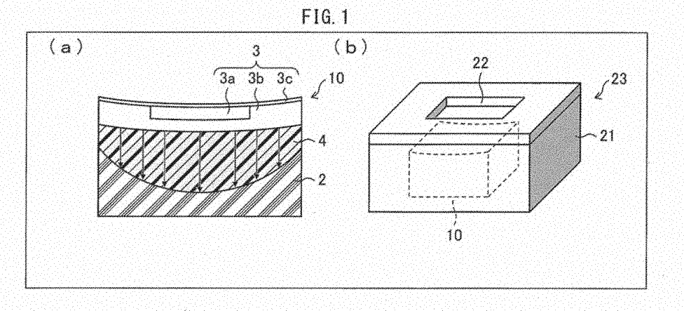

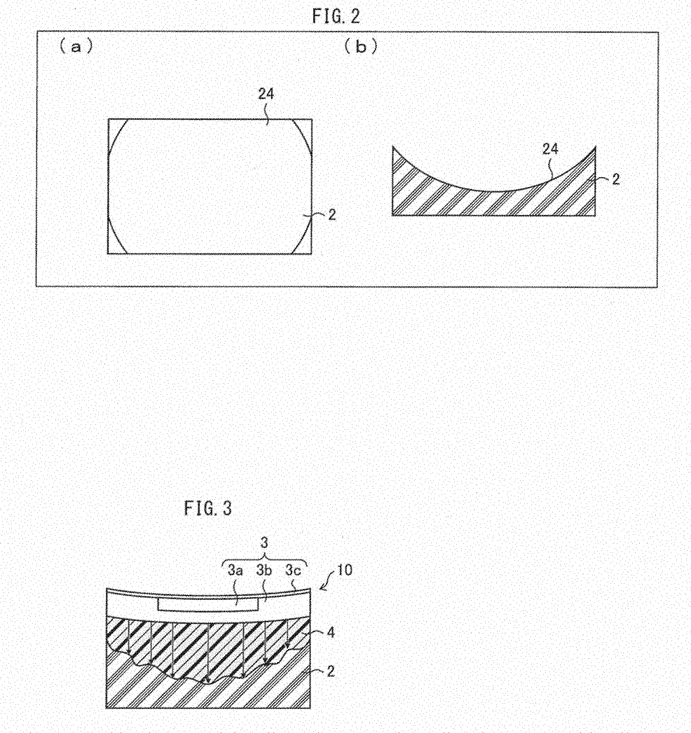

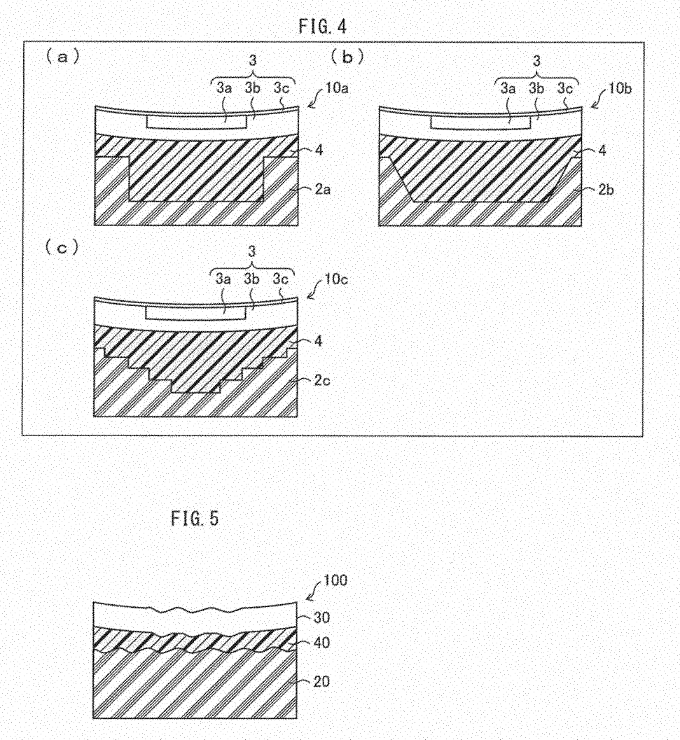

As can be seen from (a) of FIG. 1, the optical device 10 is configured such that the resin layer 4 has a larger thickness at a central region of the LCOS element 3 than at a peripheral region of the LCOS element 3. Consequently, as illustrated in FIG. 3, even if a surface of the heater substrate 2 (interface of the heater substrate 2 with the resin layer 4) has concavity and convexity due to waviness, a foreign matter, scar etc., the central region of the LCOS element 3 is less likely to be influenced by such concavity and convexity than the peripheral region of the LCOS element 3 is. That is, since the influence of the concavity and convexity of the heater substrate 2 at the central region of the LCOS element 3 is absorbed by the resin layer 4 with a large thickness (by the thick resin layer 4), it is possible to subdue deformation of the central region of the LCOS element 3 along the concavity and convexity. The central region of the LCOS element 3 has an active region. Since the deformation of the central region along the concavity and convexity is subdued, it is possible to avoid a significant decrease in optical performance.

Furthermore, since the resin layer 4 has a smaller thickness at the peripheral region of the LCOS element 3 than at the central region of the LCOS element 3, it is easier to transmit, to the LCOS element 3, heat for increasing performance of the LCOS element 3 than a case where the resin layer 4 is thick on the whole region of the LCOS element 3. That is, it is possible to avoid a significant decrease in optical performance without blocking supply of heat from the heater substrate 2 to the LCOS element 3.

In most cases, the concavity and convexity of the heater substrate 2 due to waviness, a foreign matter, scar etc. are not less than 10 μm and not more than 100 μm. Accordingly, when the resin layer 4 laminated on the heater substrate 2 has a thickness of not less than 10 μm and not more than 100 μm, it is possible for the resin layer 4 to sufficiently absorb the concavity and convexity of the heater substrate, thereby assuring performance of the optical element.

Furthermore, in the present embodiment, the resin layer 4 continuously increases its thickness from the peripheral region of the LCOS element 3 to the central region of the LCOS element 3.

As described above, the optical device 10 hardly suffers deformation at the central region of the LCOS element 3, and accordingly can avoid a significant decrease in optical performance. Accordingly, it is possible to realize the optical device 10 with high quality, having assured performance of the LCOS element 3.

As illustrated in (b) of FIG. 1, the optical device 10 is contained, for example, in a package (housing) 21 and is used an optical switch 23. The package 21 illustrated as an example in (b) of FIG. 1 is provided with an optical window 22 into which an optical glass is fit. Light is incident to and reflected from the optical device 10 via this optical window. Such a package may be conventionally known one selected depending on the type and/or intended use of an optical device to be contained in the package, and accordingly an explanation of the package is omitted. Furthermore, an explanation of use of the optical switch 23 is omitted because a conventionally known technique is usable.

### Method for Producing Optical Device

First, a plate-like ceramic material is subjected to cutting processing so that the ceramic material has a depression from its periphery to its center, i.e. the ceramic material has a mortar shape as illustrated in (b) of FIG. 2. Thus, a heater substrate is formed. A heating circuit and a temperature control circuit are provided on the heater substrate thus formed, so that the heater substrate 2 is formed.

A resin is applied onto the heater substrate 2 formed as above, and the LCOS element 3 is provided on the resin, and the resin is thermally cured. The resin having been thermally cured serves as the resin layer 4.

The following description will discuss modifications of the optical device 10.

### Modification 1

(a) of FIG. 4 is a cross sectional view of an optical device 10 which is a modification of the optical device 10. As illustrated in (a) of FIG. 4, the optical device 10a has a heater substrate 2a which is different in shape from the heater substrate 2. The optical device 10a has the same configuration as that of the optical device 10 except for the shape of the heater substrate 2a.

As illustrated in (a) of FIG. 4, the heater substrate 2a is shaped such that, at an interface with the resin layer 4, a central region of the heater substrate 2a is depressed by one step from a peripheral region of the heater substrate 2a. In other words, the heater substrate 2a is configured such that its peripheral region is positioned higher by one step than its central region, or such that its peripheral region has a frame portion.

### Modification 2

(b) of FIG. 4 is a cross sectional view of an optical device 10b which is another modification of the optical device 10. As illustrated in (b) of FIG. 4, the optical device 10b has a heater substrate 2b which is different in shape from the heater substrate 2. The optical device 10b has the same configuration as that of the optical device 10 except for the shape of the heater substrate 2b.

As illustrated in (b) of FIG. 4, the heater substrate 2b is shaped such that, at an interface with the resin layer 4, a central region of the heater substrate 2b is positioned lower by one step than a peripheral region of the heater substrate 2b, and the step is inclined. In the heater substrate 2b, the central region is positioned lower by one step than the peripheral region, but alternatively may be positioned lower by plural steps than the peripheral region.

### Modification 3

(c) of FIG. 4 is a cross sectional view of an optical device 10c which is still another modification of the optical device 10. As illustrated in (c) of FIG. 4, the optical device 10c has a heater substrate 2c which is different in shape from the heater substrate 2. The optical device 10c has the same configuration as that of the optical device 10 except for the shape of the heater substrate 2b.

As illustrated in (c) of FIG. 4, the heater substrate 2c is shaped such that, at an interface with the resin layer 4, the heater substrate 2c is depressed stepwise from its peripheral region to its central region. The number of steps is not limited. Since the heater substrate 2c is depressed stepwise from its peripheral region to its central region, the thickness of the resin layer increases stepwise from the peripheral region to the central region.

Also in the optical devices 10a, 10b, and 10c in accordance with the modifications, the resin layer 4 has a larger thickness at the central region of the LCOS element 3 than at the peripheral region of the LCOS element 3. Accordingly, even if the surfaces of the heater substrates 2a, 2b, and 2c have concavity and convexity, the central region of the LCOS element 3 hardly suffer deformation, so that a significant decrease in optical performance of the optical devices 10a, 10b, and 10c can be avoided. Therefore, it is possible to realize the optical devices 10a, 10b, and 10c with high quality, having assured performance of the LCOS element 3.

In the methods for producing the optical devices 10a, 10b, and 10c in accordance with the modifications, the heater substrate may be formed by subjecting a central region of a plate-like ceramic material to cutting processing, or may be formed by laminating a frame-like ceramic material on a plate-like ceramic material (in Modification 3, laminating different types of frame-like ceramic materials on a plate-like material). The frame-like ceramic material may be circular or polygonal. In Modifications 1 and 2, processing is easier because only one frame-like ceramic material is used.

In the aforementioned embodiment and modifications thereof, a description was made as to the optical device including the LCOS element as an optical element. However, the optical element included in the optical device of an aspect of the present invention is not limited to this. The optical element included in the optical device of an aspect of the present invention may be any optical element as long as the optical element is used together with the heater substrate. For example, the optical element may be an MEMS (Micro Electro Mechanical System) mirror element.

### SUMMARY

An optical device in accordance with the present embodiment includes: an optical element; a heater substrate for heating the optical element; and a resin layer provided between the optical element and the heater substrate, the resin layer having a larger thickness at a central region of the optical element than at a peripheral region of the optical element.

With the arrangement, since the resin layer has a larger thickness at the central region of the optical element than at the peripheral region of the optical element, even if a surface of the heater substrate which surface faces the optical element (interface of the heater substrate with the resin layer) has concavity and convexity due to waviness, a foreign matter, scar etc., the central region of the optical element is less likely to be influenced by the concavity and convexity than the peripheral region of the optical element is. That is, since the influence of the concavity and convexity of the heater substrate at the central region of the optical element is absorbed by the resin layer with a large thickness (by the thick resin layer), it is possible to subdue deformation of the central region of the optical element along the concavity and convexity.

In most optical elements, an active region which has an optical function exists not at a peripheral region of the optical element but at a central region of the optical element. Consequently, deformation of the central region of the optical element results in a decrease in optical performance of the optical element. In contrast, in the optical device in accordance with the present embodiment, the central region of the optical element hardly suffers deformation, so that a significant decrease in optical performance can be avoided.

Furthermore, with the arrangement, since the resin layer has a smaller thickness at the peripheral region of the optical element than at the central region of the optical element, it is easier to transmit, to the optical element, heat from the heater substrate than a case where the resin layer is thick on the whole region of the optical element. That is, it is possible to avoid a significant decrease in optical performance without blocking supply of heat from the heater substrate to the optical element.

In addition to the above arrangement, it is preferable to arrange the optical device in accordance with the present embodiment such that the resin layer has a larger thickness at the central region of the optical element than at the peripheral region of the optical element, due to a concave portion at a surface of the heater substrate which surface faces the optical element.

With the arrangement, the resin layer can have a larger thickness at the central region of the optical element than at the peripheral region of the optical element simply by forming a concave portion at the surface of the heater substrate which surface faces the optical element.

In addition to the above arrangement, it is preferable to arrange the optical device in accordance with the present embodiment such that the thickness of the resin layer is not less than 10 μpm and not more than 100 μm at the central region.

Normally, the concavity and convexity of the heater substrate due to waviness, a foreign matter, scar etc. are not less than 10 μm and not more than 100 μm. Accordingly, when the resin layer laminated on the heater substrate has a thickness of not less than 10 μm and not more than 100 μm, it is possible for the resin layer to sufficiently absorb the concavity and convexity of the heater substrate. This makes it possible to more effectively avoid a decrease in performance of the optical element.

In addition to the above arrangement, it is preferable to arrange the optical device in accordance with the present embodiment such that the optical element has an active region at the central region.

With the arrangement, the active region of the optical element hardly suffers deformation, so that it is possible to more effectively avoid a decrease in performance of the optical element.

In addition to the above arrangement, it is preferable to arrange the optical device in accordance with the present embodiment such that the optical element is an optical element constituted by laminating different types of materials, such as an LCOS element.

It is often that an optical element in which different types of materials are laminated, such as an LCOS element, is curved due to a difference in expansion coefficient between individual layers. When the optical element is curved, a central region of the optical element is closer to a surface of the heater substrate than a peripheral region of the optical element is, so that the central region of the optical element is likely to suffer deformation along concavity and convexity of the heater substrate. In contrast, in the optical device in accordance with the present embodiment, since the resin layer has a larger thickness at the central region of the optical element than at the peripheral region of the optical element, so that the central region of the optical element hardly suffers deformation along concavity and convexity of the heater substrate. Therefore, with the above arrangement, it is possible to effectively avoid a decrease in performance of an optical element constituted by laminating different types of materials, such as an LCOS element.

In addition to the above arrangement, it is preferable to arrange the optical device in accordance with the present embodiment such that the thickness of the resin layer increases continuously from the peripheral region to the central region.

Furthermore, it is preferable to arrange the optical device in accordance with the present embodiment such that the thickness of the resin layer increases stepwise from the peripheral region to the central region.

Furthermore, an optical switch in accordance with the present embodiment includes any of the aforementioned optical devices.

With the arrangement, it is possible to provide an optical switch with assured performance.

### Additional Matter

The present invention is not limited to the description of the embodiment and the modifications above, but may be altered by a skilled person within the scope of the claims. An embodiment based on a proper combination of technical means disclosed in the embodiment or the modifications is encompassed in the technical scope of the present invention.

### INDUSTRIAL APPLICABILITY

The present invention is applicable to, for example, an optical device in which an optical element such as an LCOS element and an MEMS element is fixed to a heater substrate via a resin layer, and to an optical switch including the optical device.

### REFERENCE SIGNS LIST

2 Heater substrate
3 LCOS element (optical element)
3a Liquid crystal layer
3b Silicon layer
4 Resin layer
10, 10a, 10b, 10c Optical device
23 Optical switch
21 Package
100 Conventional optical device

1. An optical device, comprising:
an optical element;
a heater substrate for heating the optical element; and
a resin layer provided between the optical element and the heater substrate,
the resin layer having a larger thickness at a central region of the optical element than at a peripheral region of the optical element.

2. The optical device as set forth in claim 1, wherein the resin layer has a larger thickness at the central region of the optical element than at the peripheral region of the optical element, due to a concave portion at a surface of the heater substrate which surface faces the optical element.

3. The optical device as set forth in claim 1, wherein the thickness of the resin layer is not less than 10 μm and not more than 100 μm at the central region.

4. The optical device as set forth in claim 1, wherein the optical element has an active region at the central region.

5. The optical device as set forth in claim 1, wherein the optical element is an optical element constituted by laminating different types of materials.

6. The optical device as set forth in claim 5, wherein the optical element is an LCOS element.

7. The optical device as set forth in claim 1, wherein the thickness of the resin layer increases continuously from the peripheral region to the central region.

8. The optical device as set forth in claim 1, wherein the thickness of the resin layer increases stepwise from the peripheral region to the central region.

9. An optical switch comprising an optical device as set forth in claim 1.
